(19) United States
(12) Patent Application Publication
(10) Pub. No.: US 2009/0154713 A1
(43) Pub. Date: Jun. 18, 2009

(54) Acoustic control apparatus for controlling acoustic in each individual space

(75) Inventor: Masahiro Kamiya, Kobe-shi (JP)

Correspondence Address: OLIFF & BERRIDGE, PLC, P.O. BOX 320850, ALEXANDRIA, VA, 22320-4850, US

(73) Assignee: FUJITSU TEN LIMITED, Kobe-Shi (JP)

(21) Appl. No.: 12/314,568

(22) Filed: Dec. 12, 2008

(30) Foreign Application Priority Data
Dec. 17, 2007 (JP) 2007-325083

(51) Int. Cl. H04R 5/00

(52) U.S. Cl. 381/1

(57) ABSTRACT

An acoustic control apparatus in an acoustic apparatus capable of playing individual sound sources in a plurality of individual spaces by executing an acoustic process for the plurality of individual spaces provided in a predetermined range of space, includes an operation display unit enabling the sound source to be individually selected in each individual space, and a playing control unit executing playing control of the sound source selected by the operation display unit in each individual space.

### CROSS-REFERENCE TO RELATED APPLICATION

This application is based upon and claims the benefit of priority of the prior Japanese Patent Application No. 2007-325083, filed on Dec. 17, 2007 in the Japanese Patent Office, the entire contents of which are incorporated by reference.

### FIELD

The present invention relates an acoustic control apparatus which plays sound sources in a plurality of individual spaces within a predetermined range of space.

### BACKGROUND

There are known acoustic apparatuses (each termed an acoustic control apparatus) for providing an environment where listeners (seaters) can listen to different categories of sound sources (music sources: CD, DVD, FM radio, etc) at respective seats defined as individual spaces within a predetermined range of space such as an internal space of a vehicle (automobile etc).

The acoustic control apparatus is equipped with speakers (or headphones) dedicated to respective seats, where the listeners sitting at the individual seats can arbitrarily select self-desired sound sources from the plurality of sound sources and can listen to the selected sound sources.

For example, a technology (apparatus 1) is proposed, in which each of the seats of the vehicle is provided with a means for selecting the sound source and a means for displaying selection statuses of a plurality of sound sources, and one single seat is equipped with a dedicated speaker while other seats are equipped with dedicated headphones. Further, another technology (apparatus 2) is proposed, in which an apparatus includes a frequency characteristic variable means for reproduced sounds so as to prevent leak sounds from the speakers of the front seats or rear seats in the car from interfering with each other.

The conventional technologies have the following problems.

In the apparatus 1, each seat is equipped with a display unit for displaying a sound source selection status. An operation of fitting the display unit to each seat is time-consuming, and a cost for the display units rises. Further, the sound sources used by other seaters at the present are displayed as not selectable sound sources on the screen of selecting the sound sources. Pieces of information indicating which seat the sound source is used at and what kind of sound source is used at the present are not, however, displayed, and it is impossible to unitarily grasp a sound source using status at each seat at one of the display units. Further, a mechanism is that the seater at each seat individually performs an operation for listening, and a drawback is that one other seater at the self-seat can not change an operation for a certain seater such as a different seater's changing a music source for a driver who is driving a vehicle in place of the driver and changing the music source for a seater disabled from adequately performing a childish operation in place of this seater. Moreover, the seater feels it troublesome putting on the headphone.

In the apparatus 2, adverse influences of reproduced sounds propagating from front seats to rear seats and from the rear seats to the front seats is restrained by changing a frequency characteristic of the reproduced sounds. These sounds can not, however, sufficiently insulated simply by changing the frequency characteristic, and an original tone might be degraded.

### SUMMARY

It is an object of the present invention to provide a technology enabling a person existing in each individual space within a predetermined range of space to individually select a sound source used at each individual space via operation display unit and capable of restraining influence of the sounds leaking from other individual spaces in each individual space.

The present invention adopts the following means in order to solve the problems given above. Namely, the present invention is an acoustic control apparatus in an acoustic apparatus capable of playing individual sound sources in a plurality of individual spaces by executing an acoustic process for the plurality of individual spaces provided in a predetermined range of space, the acoustic control apparatus including: an operation display unit enabling the sound source to be individually selected in each individual space; and a playing control unit executing playing control of the sound source selected by the operation display unit in each individual space.

According to the present invention, the sound source used at each individual space can be individually selected. Further, the playing control unit executes the playing control of the sound source to be played at each individual space, whereby a proper listing environment can be provided at each individual space. The predetermined range of space according to the present invention connotes, e.g., an internal space of a vehicle (moving body) like an automobile and an internal space of a building. The individual space according to the present invention stands for, for example, the seat of the vehicle such as the automobile.

Furthermore, the operation display unit according to the present invention is installed in a proper position which is visually recognized from each individual space. This arrangement enables a person existing in each individual space to visually recognize the sound source used at each individual space.

Moreover, the acoustic control apparatus according to the present invention may further include a remote control accepting unit accepting an operation from a remote control unit. With this configuration, the person existing in each individual space (especially the person existing beyond a range enabling the operation display unit to be manually operated) can smoothly select the sound source used at the self-seat or other-seat. This configuration enables the person existing in each individual space to smoothly select the individual space and the sound source in place of other persons.

In the acoustic control apparatus according to the present invention, it is preferable that the operation display control unit displays an individual space selection screen for selecting at least one individual space in which the individual sound source is played from within the predetermined range of space, displays a sound source selection screen for selecting, when the individual space is selected via the individual space selection screen, the sound source used with respect to the selected individual space from a plurality of sound sources usable within the predetermined range of space, and accepts the selection result of the individual space and the sound source as the selection result employed by the playing control unit via the individual space selection screen and the sound source selection screen.

With this scheme, the person existing in each individual space can select the individual space (symbol) and the sound source by use of the operation display unit.

Further, in the acoustic control apparatus according to the present invention, it is preferable that the operation display control unit displays a sound source selection screen for selecting a desired sound source from the plurality of sound sources usable within the predetermined range of space, displays, when the sound source is selected via the sound source selection screen, an individual space selection screen for selecting the individual space in which the acoustic data of the selected sound source is reproduced from the selected sound source from within the predetermined range of space, and accepts the selection result of the individual space and the sound source as the selection result employed by the playing control unit via the sound source selection screen and the individual space selection screen.

This scheme enables the person existing in each individual space can select the individual space and the sound source by use of the operation display unit.

Still further, in the acoustic control apparatus according to the present invention, it is preferable that the operation display unit displays categories of the sound sources played in the individual spaces within the predetermined range of space on the same screen.

This scheme also enables the person existing in each individual space to unitarily and visually recognize the categories of the sound sources employed in each individual spaces. Moreover, in addition to the categories of the sound sources, output acoustic attribute data (a music title, a name of a player, a broadcasting frequency, a title of a broadcasting program, etc) may also be displayed.

Yet further, in the acoustic control apparatus according to the present invention, such a configuration can be taken that the playing control unit, when the single sound source is played in the predetermined range of space as the selection result of the individual space and the sound source, plays the selected single sound source synchronously in the individual spaces.

With this scheme, in the case of using the single sound source within the predetermined range of space, it is feasible to obviate desynchronized sounds with other individual spaces and to make the person listen to the sounds properly in each individual space.

Moreover, in the acoustic control apparatus according to the present invention, such a configuration can be taken that the playing control unit executes as a playing control at least any one of leak sound control of generating and outputting control sounds for canceling sounds leaking from other individual spaces with respect to each individual space, and localization control of generating a virtual sound field having a virtual sound image based on the output signal of the sound source in the individual space with respect to each individual space, and correcting a position of the sound image.

With this scheme, the playing control unit outputs the control sounds for canceling the sounds leaking from other individual spaces, whereby the leak sounds are reduced (muted) in each individual space. Further, an individual acoustic environment exhibiting a realistic ambience can be provided by generating a virtual sound field having a virtual sound image based on output signals of the sound source to be played in each individual space and correcting a position of the sound image.

The present invention can be realized as the invention of a method having the same features as those of the acoustic control apparatus described above, the invention of a program for making a computer function as the acoustic control apparatus and the invention of a recording medium recorded with the program.

According to the present embodiment, the person existing in each individual space within a closed space can individually select the sound source used in each individual space by utilizing the operation display unit, and the influence of the sounds leaking from other individual spaces can be restrained in each individual space.

### BRIEF DESCRIPTION OF DRAWINGS

FIG. 1 is a conceptual diagram of a vehicle mounted with an acoustic control apparatus;

FIG. 2 is a diagram illustrating a system architecture example of the acoustic control apparatus;

FIG. 3 is a block diagram illustrating a system example for a playing control process executed by a playing control unit;

FIG. 4 is a flowchart illustrating an operational example of the acoustic control apparatus when selecting a seat (symbol) and a sound source;

FIG. 5 is a diagram illustrating an example of how a display screen of a touch panel display transits when in the operational example in FIG. 4;

FIG. 6 is a flowchart illustrating an operational example of the acoustic control apparatus 200 when selecting the sound source and the seat;

FIG. 7 is a diagram illustrating an example of how the display screen of the touch panel display 108 transits when in the operational example in FIG. 6;

FIG. 8 is a diagram illustrating an example of the screen for displaying a sound source selection status at each seat.

### DESCRIPTION OF EMBODIMENT

An embodiment of the present invention will hereinafter be described with reference to the drawings. Note that the following discussion will deal with a case in which an acoustic control apparatus according to the present invention is mounted in a vehicle (for example, an automobile). A configuration in the following embodiment is an exemplification, and the present invention is not limited to the configuration in the embodiment.

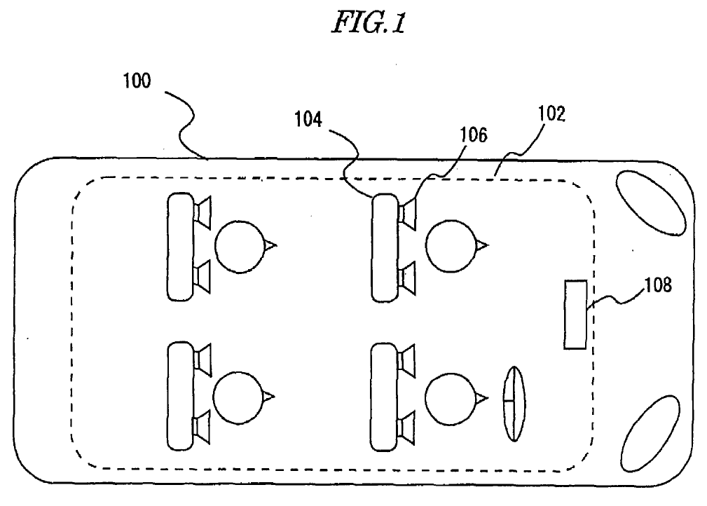

FIG. 1 is a conceptual diagram of the vehicle mounted with the acoustic control apparatus according to the present invention. A vehicle 100 has an in-car space 102 defined as a closed space, and a plurality of seats 104 defined as individual spaces are disposed in the in-car space 102. FIG. 1 illustrates an example having the four seats in two lines, however, a 6-seat/3-line arrangement is available, and the acoustic control apparatus is limited to neither a specified line count nor a specified seat count.

Each seat 104 includes a backrest and a headrest, and a pair of speakers 106 is fitted to the headrest in such a state that the speakers 106 are installed in the vicinity of ears of a seater (who is a generic term of both a driver and a passenger). The speaker for the right ear and the speaker for the left ear are paired into the speakers 106. Incidentally, the fitting positions of the speakers are not limited to the headrest; however, the speakers may be fitted in the vicinity of shoulder portions of the backrest.

Further, a touch panel display 108, functioning as a controller/display device on which a music source (sound source) is selectively operated and a selected status of the music source is displayed at each seat 104, is installed in front of the in-car space 102.

The touch panel display 108 includes a touch panel (touch screen) serving as a display panel and a plurality of physical buttons and switches, and is capable of displaying a variety of operation screens containing images of the operation buttons and of the operation switches. Moreover, the touch panel display 108 is contrived so that a touch position on the touch panel is specified when pressed, and a function corresponding to the operation button or the operation switch specified by the touch position on the operation screen is realized. The touch panel display 108 is disposed in a position (at the center of the front of the in-car space 102 in FIG. 1 enabling the display to be easily visually recognizable from every seat 104.

Note that the touch panel display 108 can be used in combination with a display panel provided in a general-purpose car navigation system. As a matter of course, the touch panel display dedicated to the acoustic control apparatus may also be mounted in the vehicle 100. Herein, the touch panel display 108 serves also as the touch panel display for the car navigation system.

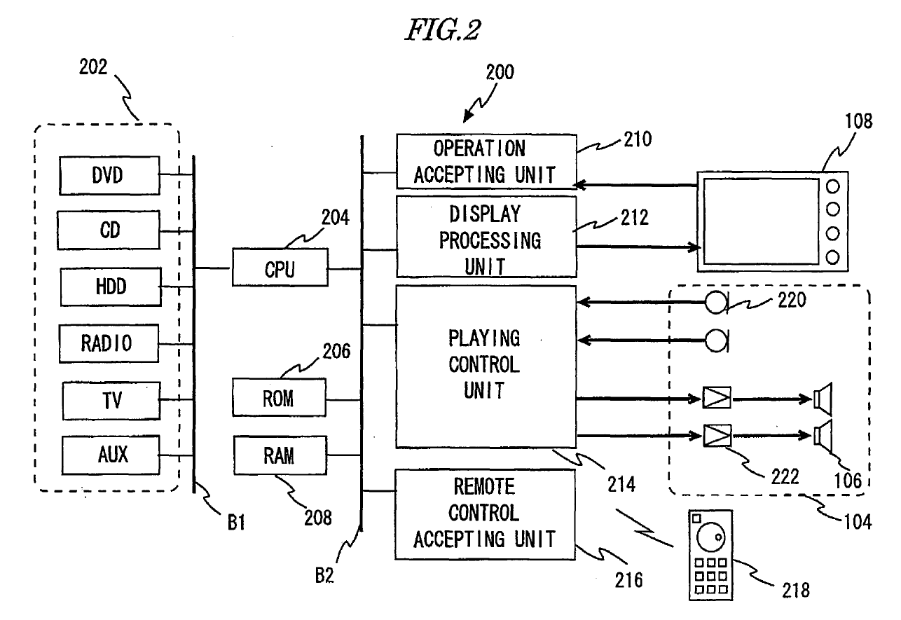

FIG. 2 is a block diagram illustrating a system architecture of the acoustic control apparatus. As illustrated in FIG. 2, an acoustic control apparatus 200 includes a sound source supply unit 202, a CPU (Central Processing Unit) 204 connected to the sound source supply unit 202 via a bus B1, a ROM (Read Only Memory) 206, a RAM (Random Access Memory) 208, an operation accepting unit 210, a display processing unit 212, a playing control unit 214 and a remote control accepting unit 216, which are mutually connected to the CPU 204 via a bus B2.

The operation accepting unit 210 and the display processing unit 212 are electrically connected to the touch panel display 108.

The playing control unit 214 is connected to each of the paired speakers 106 via amplifiers 222 corresponding to the respective speakers 106. Further, the playing control unit 214 is connected to a pair of error microphones 220 for collecting voices leaking from other seats. Note that FIG. 2 illustrates the amplifiers 222, the speakers 106 and the error microphones 220 for one seat 104, however, these components are provided at every seat.

The remote control accepting unit 216 is configured to receive a control signal transmitted from a remote controller (remocon) 218 defined as a remote control unit, corresponding to an input to the remote controller 218, through non-contact communications (for example, infrared-ray communications, wireless communications) from the remote controller 218.

The sound source supply unit 202 is constructed of a plurality of sound sources such as a drive device (reading device) for a recording medium stored with sound source data (acoustic data) that is exemplified by a CD (Compact Disk), a DVD (Digital Versatile Disk) and a HD (Hard Disk), a receiver for a radio broadcast and a television (TV) broadcast, and an input terminal like an AUX terminal for the acoustic data sent front external equipment.

The display processing unit 212 displays, based on an instruction given from the CPU 204, a variety of operation screens on the touch panel of the touch panel display 108.

The operation accepting unit 210 can specify, based on, for example, a signal input from the touch panel display 108, the pressed position on the touch panel and can transmit a signal indicating this pressed position to the CPU 204. Further, the operation accepting unit 210 can receive the signal input by operating the button or the switch provided in the vicinity of the touch panel of the touch panel display 108, and can notify the CPU 204 of an operation content (control content) corresponding to this input signal.

Note that the operation accepting unit 210 may also be configured to previously have the information (the allocation information of the buttons and the switches on the operation screen) on the operation screen, then specify the button or the switch pressed on the operation screen from the pressed position on the touch panel, and transmit the signal representing the operation content (the control content) corresponding to these operations to the CPU 204.

The playing control unit 214 can execute a playing process of the sound source data (the acoustic data read from the CD and the DVD, the acoustic data based on the acoustic signals received from the radio and the TV receiver, and the acoustic data input to the AUX terminal) given from the sound source supply unit 202, and can output reproduced acoustic signals to the amplifiers 222.

The remote control accepting unit 216 is capable of generating signals indicating the operation content (the control content) input by use of the remote controller 218 from the signals received from the remote controller 218, and can transmit the thus-generated signals to the CPU 204. The remote control accepting unit 216 includes a receiving unit for receiving non-contact signals (radio signals, infrared-ray signals, etc) containing the control signals transmitted from the remote controller 218, and the receiving unit is installed in the vicinity of, for example, the touch panel display 108 so as to enable the signals from the remote controller 218 to be received in an acceptable state irrespective of the seat position.

The ROM 206 is a storage medium stored with various categories of programs such as programs for actualizing the car navigation system and programs for making the CPU 204 function as a control device of the acoustic control apparatus and with data used when executing the respective programs.

The RAM 208 is defined as an work area employed when the CPU 204 loads and executes the programs stored in the ROM 206.

The CPU 204 is a control device which executes the processes for realizing the functions of the car navigation system and of the acoustic control apparatus through the execution of the respective programs. For example, the CPU 204 gives, through the execution of the programs, the data and instructions for displaying the variety of operation screens on the touch panel of the touch panel display 108 to the display processing unit 212. Farther, the CPU 204 receives the signals accepted by the operation accepting unit 210 through the operations on the touch panel display 108 and the signals accepted by the remote control accepting unit 216 through the operations of the remote controller 218, then analyzes the operation contents (the control contents) from these signals, and executes the processes corresponding to the operation contents.

For example, when the operation contents include selected seat information (designated seat information), selected sound source information (designated sound source information) and an instruction for outputting the sound from the designated sound source to the designated seat, the CPU 204 gives a read instruction to the designated sound source of the sound source supply unit 202, and receives the acoustic data output from the designated sound source in response to this instruction. Then, the CPU 204 gives the acoustic data and the designated seat information to the playing control unit 214. The playing control unit 214 links the sound (voice) based on the acoustic data with the amplifiers 222, thereby outputting the sound from the speakers 106 of the designated seat.

Further, the playing control unit 214 at each seat executes a process of canceling the sounds (leak sounds) leaking from other seats on the basis of the acoustic signals at other seats and the signals of the error microphones 220 at other seats. A playing control process executed by the playing control unit 214 will be explained. Note that a playing control processing system described herein is exemplified by way of one example, and the acoustic control apparatus 200 can be also applied to other playing control processing systems.

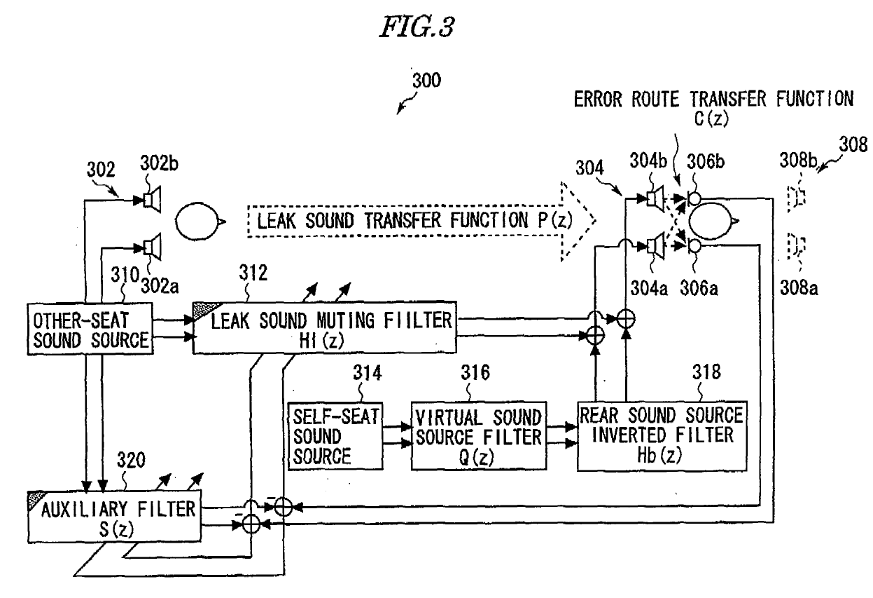

FIG. 3 is a block diagram illustrating the example of the playing control processing system actualized mainly by the playing control unit 214. The playing control processing system illustrated in FIG. 3 includes an other-seat speaker 302, a self-seat speaker 304, a self-seat error microphone 306, an other-seat sound source 310, a leak sound muting filter 312, a self-seat sound source 314, a virtual sound source filter 316, a rear sound source inverted filter 318 and an auxiliary filter 320. Note that the sounds provided from the self-seat speaker 304 have a virtual sound source 308 defined as a virtually set sound source provided in front of the seater at the self-seat. Further, the leak sound muting filer 312 with a left upper angular portion dotted in black and the auxiliary filter 320 represent ADFs (Adaptive Digital Filters).

In a playing control processing system 300 illustrated in FIG. 3, the auxiliary filter 320, for effectively reducing the sounds leaking from the other-seat speaker 302 to the seater at the self-seat, executes dynamic estimate of a leak sound transfer function P(z) between the other-seat speaker 302 and the self-seat error microphone 306 and an error route transfer function C(z) between the self-seat speaker 304 and the self-seat error microphone 306, and the leak sound muting filter 312 generates control sounds for canceling the leak sounds from other seats by use of the leak sound transfer function P(z) and the error route transfer function C(z). Moreover, a sound image is localized in front of the seater by employing the virtual sound source filter 316 and the rear sound source inverted filter 318 in order to provide an individual acoustic environment exhibiting realistic ambiance.

The other-seat speaker 302 includes an other-seat right speaker 302a and an other-seat left speaker 302b, which are fitted, for example, in the vicinity of the headrest or the shoulder portions of the backrest of the rear seat in the vehicle. Incidentally, the other-seat speaker 302 is connected to the other sound source 310 via the amplifiers 222 (not illustrated in FIG. 3), and outputs the sound source which the seater sitting at the other seat selects.

The self-seat speaker 304 includes a self-seat right speaker 304a and a self-seat left speaker 304b, which are fitted, for example, in the vicinity of the headrest or the shoulder portions of the backrest of the driver seat in the vehicle. Note that the self-seat speaker 304 is connected to the leak sound muting filter 312 and the rear sound source inverted filter 318 via the amplifiers 222 (FIG. 3), outputs the acoustic sound like the music and the voices which the seater sitting at the self-seat selects, and also outputs the control sounds for canceling the leak sounds from other-seat speaker 302.

The self-seat error microphone 306 (corresponding to the error microphones 220) includes a right error microphone 306a and a left error microphone 306b, which are fitted in front of the self-seat right speaker 304a and the self-seat left speaker 304b building up the self-seat speaker 304. Incidentally, the self-seat speaker 306 is fitted, for example, in the same way as the self-seat speaker 304 is, in the vicinity of the headrest or the shoulder portions of the backrest of the driver seat in the vehicle. Then, the acoustic signals (leak sounds) collected by the self-seat error microphone 306 are output to the auxiliary filter 320 and used for estimating the leak sound transfer function P(z) and error route transfer function C(z).

The other-seat sound source 310 is a device for playing the music and voices stored on the portable storage medium such as the CD and the DVD, the music and the voices (acoustic data) stored on the HDD, and the sound sources (acoustic sources) of the radio, the TV, the car navigation system, etc. The other-seat sound source 310 is realized by the sound source supply unit 202, the CPU 204, and the playing control unit 214. Note that the output of the other-seat sound source 310 is input to the other-seat speaker 302 and, in addition, to the leak sound muting filter 312 and the auxiliary filter 320 as well.

The leak sound muting filter 312 is a filter which generates the control sounds for canceling the leak sounds from the other-seat speaker 302 by use of the leak sound transfer function P(z) and the error route transfer function C(z), which are estimated based on the output of the auxiliary filter 320. Note that the leak sound muting filter 312 is constructed as the ADF (Adaptive Digital Filter).

Herein, a calculation procedure of the leak sound muting filter 312 will be briefly explained. Let [HI(z)] be the leak sound muting filter 312, [S(z)] be the auxiliary filter 320, [P(z)] be the leak sound transfer function and [C(z)] be the error route transfer function, a relation therebetween is expressed by the following formula: S(z)=P(z)+HI(z) C(z).

In the formula S(z)=P(z)+HI(z) C(z), two sets of initial values (S1(z), HI1(z) and S2(z), HI2(z)) are inputted to S(z) and HI(z), and the optimal leak sound transfer function P(z) and the optimal error route transfer function C(z) can be estimated by updating S1(z) and S2(z) so as to minimize the cancellation error. An optimal value of HI(z) is given by the formula: HI(z)=−P(z)/C(z). It is to be noted that the initial values S1(z), S2(z), HI1(z), and HI2(z) of S(z) and HI(z) are calculated by processing the output signal from the self-error microphone 306 and the output signal from the other-seat sound source 310 with the not illustrated filter etc, and given to the auxiliary filter 320.

The self-seat sound source 314 is a device for playing the music and voices (acoustic data) stored on the portable storage medium such as the CD and the DVD, the music and the voices stored on the HDD, and the sound sources of the radio, the TV, the car navigation system, etc. The self-seat sound source 314 is realized by the sound source supply unit 202, the CPU 204 and the playing control unit 214. Note that the output of the self-seat sound source 314 is input to the self-seat speaker 304 via the virtual sound source filter 316 and via the rear sound source inverted filter 318.

The virtual sound source filter 316 is a filter (Q(z)) which receives the input from the self-seat sound source 314 and generates a virtual sound field including the virtual sound image in front of the seater of the self-seat. Note that the virtual sound field generated by the virtual sound source filter 316 is what the signals from the self-seat sound source 314 are processed as if the sound source exists in front of the seater as the virtual sound source 308 is illustrated in FIG. 3.

Further, the virtual sound source filter 316 can, since the transfer function is the function obtained beforehand based on the in-advance measurement result etc, acquire the sound field having the realistic ambiance without applying the processing load. Herein, the in-advance measurement described above is done in such a way that the voices are uttered from the two speakers installed in front of a dummy head simulating the seater, and impulse responses in ear positions are measured by microphones fitted in the ear positions of the dummy head. Then, a target transfer function in a target sound field is obtained based on a result of the measurement described above, and the thus-obtained target transfer function is set as Q (z).

The rear sound source inverted filter 318 is a filter defined as an inverted function of the error route transfer function C(z) between the self-seat speaker 304 and the self-seat error microphone 306 and executing a process of localizing the virtual sound field based on the position of the self-seat speaker 304 in the position of the self-seat error microphone 306. With this scheme, it is feasible to correct the rear localization of the sound field, which is derived from fitting the self-seat speaker 304 behind the seater. Note that let [Hb(z)] be the rear sound source inverted filter 318, and Hb(z) is given by the formula [Hb(z)=1/C(z)]. It is to be noted that C(z) in this formula involves using a static error route transfer function that is estimated beforehand.

The auxiliary filter 320 is a filter which executes a process of estimating the leak sound transfer function P(z) and the error route transfer function C(z) on the basis of the inputs from the other-seat sound source 310 and the self-seat error microphone 306. Then, the output of the auxiliary filter 320 is used for the adaptive control of the leak sound muting filter 312.

Thus, the operational accuracy of the leak sound muting filter 312 can be improved by executing dynamic estimation of the error route transfer function C(z) that is easy to change corresponding to the environmental change. Further, the virtual sound source filter 316 generates the sound having the sound image existing in front of the seater, and moreover the rear sound source inverted filter 318 localizes the sound image based on the position of the self-seat speaker 304 in the position of the self-seat error microphone 306 in close proximity to the ear positions of the seater, thereby enabling the individual acoustic environment exhibiting the realistic ambiance to be provided. Note that the in the configurations illustrated in FIGS. 1-3, the touch panel display 108, the operation accepting unit 210, the display processing unit 212 and the CPU 204 function as the operation accepting unit according to the present invention. Further, the CPU 204 and the playing control unit 214 function as the playing control unit according to the present invention. Still further, the remote control accepting unit 216 functions as the remote control accepting unit according to the present invention.

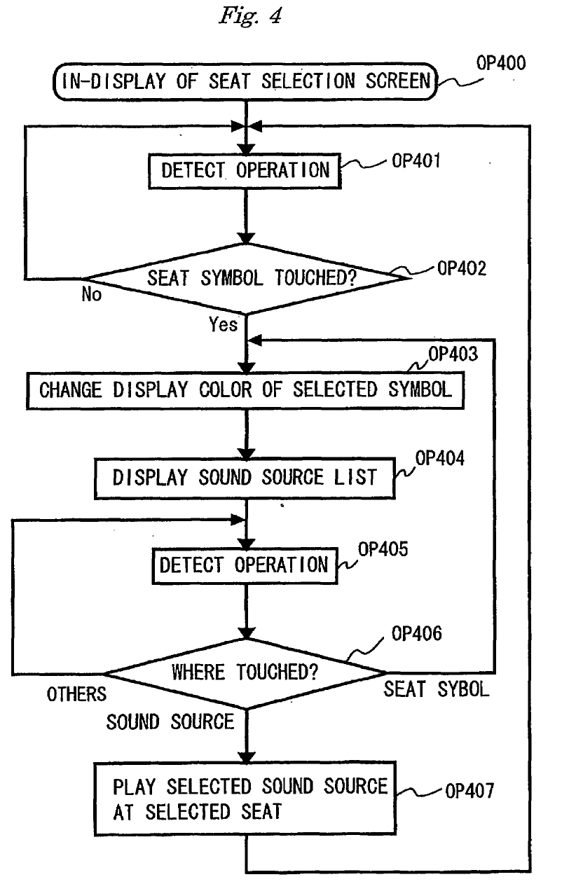

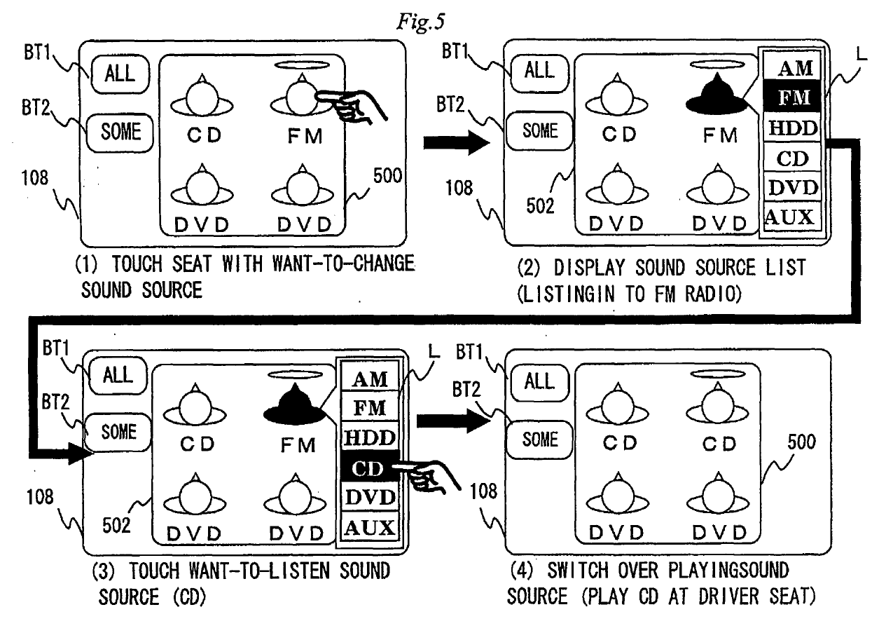

Next, an operational example of the acoustic control apparatus 200 when selecting the sound source will be described with reference to FIGS. 4 and 5. FIG. 4 is a flowchart illustrating the operational example of the acoustic control apparatus in the case of selecting the seat where the sound source is played and selecting the playing target sound source at the selected seat. This process is executed by, for example, the CPU 204. FIG. 5 is a diagram illustrating a transit example of the display screen of the touch panel display 108 in the operation in the flowchart of FIG. 4.

To start with, when the seater touches the button for making a transition to a seat selection screen displayed on the touch panel of the touch panel display 108, a seat selection screen 500 (FIG. 5) is displayed (OP 400, FIG. 5(1)).

When the seater touches the seat (expressed by a symbol of the seater in FIG. 5) of the seater who desires to output the acoustic data by referring to the seat selection screen 500, the CPU 204 detects the operation on the touch panel via the operation accepting unit 210 (OP401), and determines whether the seat area (the seat symbol) is touched or not (OP402). When the seat symbol is touched (OP402: Yes), the CPU 204 gets, on the assumption that the seat is designated, the display processing unit 212 to change a display color of the touched seat symbol on the seat selection screen 500 (OP403) and to display a list of categories of reproducible (usable) sound sources for the designated seat (OP404).

Namely, the seat selection screen 500 transits to a sound source selection screen 502 on which to display marks representing plural categories of sound sources selectable at the seat as a list L on the seat selection screen 500 (FIG. 5(2)). At this time, when there is the sound source that is under the selection (playing) at the seat, the category mark of this sound source is displayed in a display color (background color) as a selection color representing that the sound source is under the selection (playing), which is different from the display colors (background colors) indicating the marks identifying the not-yet-selected sound sources (FIG. 5(2)).

In OP402, when an area excluding the seat symbols is touched (OP402: No), the display screen of the touch panel display 108 does not transit from the seat selection screen 500 but comes to a standby status till the next operation is done.

Next, in OP404, when the seater touches a want-to-listen sound source from the sound source list on the sound source selection screen 502, the CPU 204 detects this operation via the operation accepting unit 210 (OP405) and determines which area is touched (OP406). When the touched area specifies any one of the plurality of sound sources in the list (OP406: sound source), the CPU 204 executes a process of playing the sound source (designated sound source) selected at the selected seat (designated seat) (OP407). At this time, the selected sound source is played, and the playing control process described above is carried out.

When the touched area is the seat other than the designated seat (OP406: seat symbol), the CPU 204 assumes that the designated seat is changed, and loops the processing back to OP403.

When the touched area is neither the sound source nor the seat (OP406: others), the CPU 204 stands by till the operation is done on the sound source selection screen 502 displaying the sound source list for the designated seat.

For example, when the seater at the passenger seat changes the sound source at the driver seat from the FM radio to the CD, at first, the screen is made to transit to the seat selection screen 500 by touching the button etc specifying [change of sound source] displayed on the touch panel display 108 (FIG. 5(1)). A sound source selected status at all of the seats is displayed on the transited seat selection screen 500.

To be specific, the categories of the sound sources used in the respective seats are displayed in the vicinities (under the symbols in FIG. 5) of the symbols (representing the seaters in FIG. 5) illustrating the respective seats. In the example in FIG. 5, on the screen 500, [FM radio] is selected as the category of the sound source at the driver seat (the seat on the upper right side on the screen), [CD] is played as the category of the sound source at the passenger seat, and [DVD] is played as the category of the sound source at the two rear seats, in which the sound source categories indicated these items are displayed.

For example, on the seat selection screen 500, when the seater at the passenger seat touches the driver seat symbol, the display color (symbol display color) of the seat specifying the driver seat is changed to a color different from those of other seats (for example, the display color of the driver seat is changed to red from white, etc). Then, the screen transits to the sound source selection screen 502 on which the list L of the sound sources reproducible (usable) at the driver seat is displayed. At this time, the FM radio is selected at the driver seat. Therefore, the area indicating [FM], which is the category of the sound source in the sound source list, is displayed in a mode of distinguishing [FM] area in a different display color (a selection color indicating the selection, for example, blue, while others are displayed in white etc) from other sound sources. When the seater at the passenger seat touches the [CD] area on the screen 502 in order to select the sound source category [CD] in the list L, the [FM] area changes to white from blue as the selection color, and the [CD] area changes to the selection color “blue” from white (FIG. 5(3)). Then, the sound source played at the driver seat is changed from the FM radio to the CD. Further, the list L is erased from within the screen, the screen returns to the original status (the seat selection screen 500) illustrating all of the seats (FIG. 5(4)). The screen, however, displays that the CD is selected at the driver seat.

In the operational example described above, the operation proceeds according to the screen display of the touch panel display 108, however, in addition to the screen display, the operation may be performed based on an output of voice guidance.

As in the present embodiment, the seat selection screen 500 displaying all of the seats in the vehicle space 102 is displayed on the touch panel display 108, in which a want-to-play-the-sound-source seat 104 is selected, the reproducible sound source list L is displayed at the selected seat (the sound source selection screen 502 is displayed), and it is feasible to unitarily set the sound sources at all of the seats and also set the different sound sources at the individual seats by selecting the want-to-play sound sources. Further, even in the case of playing the different sound sources at the respective seats, the playing control process is carried out, and it is therefore possible to provide the music having the high sound quality by reducing (muting) the leak sounds from the front and rear seats and the right and left seats around the self-seat without taking trouble to put on the headphone etc.

Note that a button BT1 for batchwise selecting all of the seats and a button BT2 for selecting a plurality of seats may also be displayed on the seat selection screen 500 in FIG. 5. When touching the button BT1 for selecting all of the seats, the CPU 204 gets, on the assumption that all of the seats are selected, the display processing unit 212 to change the display color of the all of the seats (the color of the “all seats” button).

When touching the button for selecting the plurality of seats, subsequently the want-to-play-the-sound-source seat is touched, whereby the CPU 204 gets, on the assumption that the plurality of seats is selected, the display processing unit 212 to change the display color of the plurality of seats touched (the color of the touched “plural seats” button).

Moreover, in the operational example described above, the touch panel display 108 has been explained by way of the operation method, however, the operation may also be performed by the remote controller 218. To be specific, the seat selection screen 500 (FIG. 5(1)) is displayed by operating the remote controller 218. In the status of displaying the seat selection screen 500, when giving a seat designation input to the remote controller 218 and inputting a transmission instruction thereto, the remote control accepting unit 216 accepts the designated seat, and the screen transits to the sound source selection screen 502 (FIG. 5(2)). Further, when giving a sound source designation input to the remote controller 218 and inputting the transmission instruction thereto, the remote control accepting unit 216 accepts the sound source designation, then the display mode of the sound source selection screen 502 transits as in FIG. 5(3), and further the screen transits to the seat selection screen 500 (FIG. 5(4)).

The operation of the remote controller 218 enables even the seater (for example, the seater at the rear seat) in an unreachable range of the touch panel display 108 to operate the display 108, and unitarily the sound sources can be smoothly set from the respective seats. At this time, each seater can, as well as setting at the self-seat, perform the setting for other seats in place of the seaters at other seats.

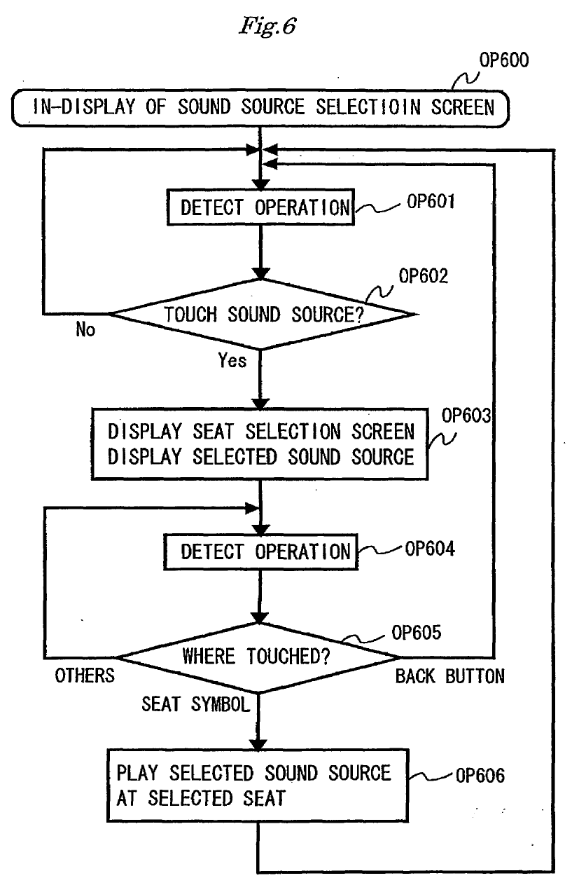

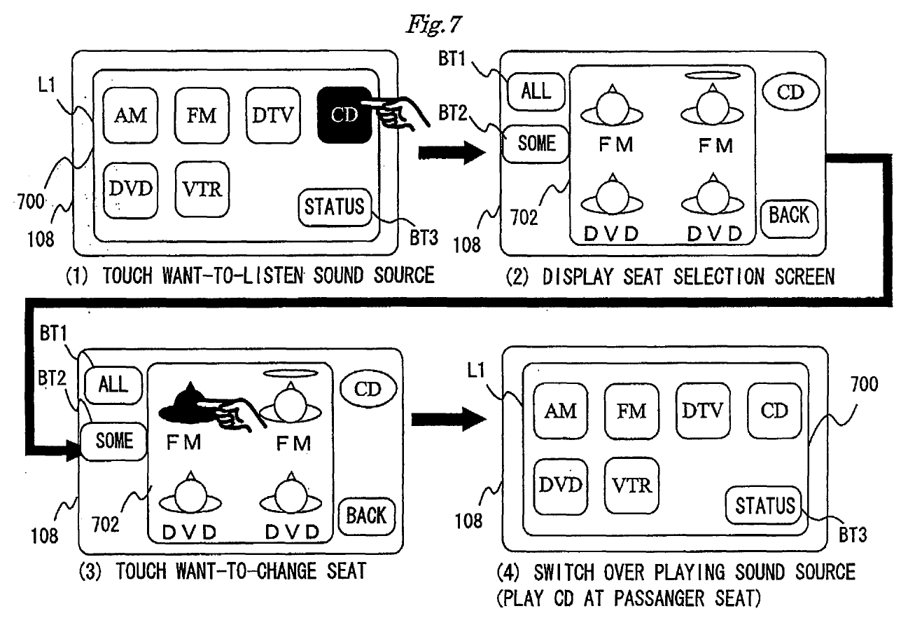

Another example of selecting (designating) the seat and the sound source by the acoustic control apparatus will be explained with reference to FIGS. 6 and 7. Note that the explanations of the overlapped portions with those in the examples in FIGS. 4 and 5 are omitted. FIG. 6 is a flowchart illustrating an operational example of the acoustic control apparatus in the case of selecting the sound source to be played and the seat at which the sound source is played. This process is executed by the CPU 204. FIG. 7 is a diagram illustrating an example of the transition of the display screen of the touch panel display 108 in the operation of the flowchart of FIG. 6.

The operation sequence in the examples illustrated in FIGS. 4 and 5 is that, to begin with, the seat is selected (designated), and the sound source, which should be played at the designated seat, is selected. By contrast, the operation sequence in examples illustrated in FIGS. 6 and 7 is that, at first, the sound source to be played is selected, and the seat, at which the sound source is played, is selected.

When the seater touches the button etc for making the transition to the screen for designating the sound source displayed on the touch panel display 108, the CPU 204 controls the display processing unit 212 to display a sound source selection screen 700 containing a list L1 of the sound sources reproducible within the in-car space 102 on the touch panel (OP600). When the seater selects a desire-to-listen sound source and touches a symbol representing this sound source category on the screen, the CPU 204 detects this operation (OP601) and determines which category in the plurality of sound source categories (CD, DVD, FM, etc) is touched (OP602). When the symbol specifying any one of the sound sources is touched (OP602: Yes), the CPU 204 makes the display content on the touch panel transit to a seat selection screen 702. The seat arrangement (the respective seats are depicted with the symbols of the seaters) and the symbol representing the category of the selected sound source (the designated sound source: the sound source category [CD] in FIG. 7) are displayed on the same seat selection screen 702 (OP603).

In OP 602, when an area other than the buttons representing the respective sound sources is touched (OP602: No), the display screen of the touch panel display 108 does not transit from the sound source selection screen 700, and the CPU 204 comes to the standby status till the next operation is done.

Next, in OP 603, when detecting the screen operation (the touch (pressing) on the touch panel) of the seater (OP604), the CPU 204 determines which element, the seat symbol or the return button or other area, is touched (OP605).

When the touched area is the seat symbol (OP605: seat), the CPU 204 executes the process of playing the sound source selected in OP602 (OP606),. At this time, the sound source selected at each seat is played, and the playing control process described above is executed. Note that the display content on the touch panel returns to the original sound source selection screen 700. The display on the seat selection screen 702 may, be maintained, and the display of the designated sound source may also be varied as the designated sound source is changed. In the example illustrated in FIG. 7, when the sound source category of the designated sound source at the passenger seat is changed from [FM] to [CD] through the seat selection screen 702, the display of the designated sound source at the passenger seat is changed to [CD] on the seat selection screen 702.

The button BT1 for selecting all of the seats and the button BT2 for selecting the plurality of seats may also be displayed on the seat selection screen 702. When touching the button for selecting all of the seats, it follows that all of the seats are selected, whereby the same designated sound source is played at all of the seats.

When touching the button for selecting the plurality of seats, the plurality of seats can be selected by subsequently touching the want-to-play-the-sound-source seats, in which the same designated sound source is played at the plurality of seats.

In OP 605, when the back button is touched (OP605: back button), the screen transits to the sound source selection screen 700 in OP600.

When other area is touched in OP605, the CPU 204 comes to the standby status till the seater performs the screen operation without transiting from the seat selection screen 702 in OP603.

For example, when the seater at the passenger seat changes the sound source at the self-seat to the CD from the FM radio, the seater touches the [CD] button on the sound source selection screen 700 (FIG. 7(1)). When done so, the color of the [CD] button changes to the selection color, and thereafter the screen transits to the seat selection screen 702 (FIG. 7(2)). The seat selection screen 702 displays how the seats are arranged and that the sound source is the CD. For others, for example, the [all] button BT1 for selecting all of the seats and the [plural] button BT2 for selecting the plurality of seats can be displayed on the same screen.

In the case of selecting only one seat, after transiting to the seat selection screen 702, the seater touches only one seat for selection. In the case of desiring to select all of the seats, all of the seats can be selected by touching the [all] button BT1. For instance, when the seater at the passenger seat wants to change the sound source at the driver seat to the same sound source, the seater at first touches the [plural] button on the seat selection screen 702 and subsequently touches both of the passenger seat and the driver seat, thereby enabling the plurality of seats to be selected and the sound sources to be changed.

For example, the seater at the passenger seat desires to change the sound source at the self-seat, the seater makes the selection by touching the seat (symbol) specifying the passenger seat (FIG. 7(3)). The color of the selected seat becomes the display color different from others for distinction therebetween. Herein, the passenger seat has been selected, and hence the color of the seat (symbol) specifying the passenger seat changes to the display color different from others. When the seat is selected, the screen again transits to the sound source selection screen, where the sound source selected at the selected seat is played (FIG. 7(4)).

According to the examples illustrated in FIGS. 6 and 7, all of the seats and the plurality of seats are selected, and the sound sources can be changed, whereby it is possible to omit the time-consuming operation of individually setting on one-by-one basis.

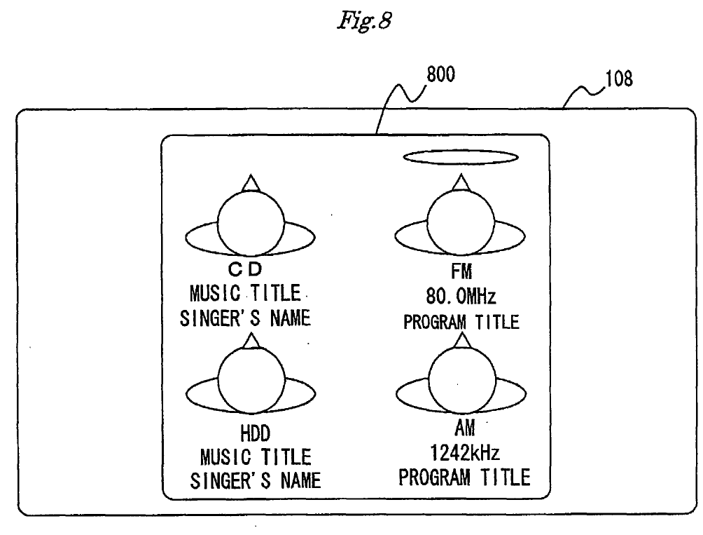

FIG. 8 is a diagram illustrating an example of a screen (sound source selection status screen) for displaying a sound source selection status at each seat. A sound source selection status screen 800 is a screen for displaying information about the sound sources selected at the individual seats at the present. The sound source selection status screen 800 can be displayed by touching, for example, a [status] button BT3 provided on the sound source selection screen 700.

The sound source information corresponding to each seat 104 in the in-car space 102 is displayed on the sound source selection status screen 800. Specifically, on the screen 800, the symbols (depicted as the seaters in FIG. B) representing the individual seats are displayed in accordance with the actual seat arrangement, and the sound source information is displayed in the vicinity (under the symbol in FIG. 8) of each seat symbol.

The sound source information can include not only the selected (designated) sound source category but also the information about the acoustic data to be played from the sound source. For instance, the sound source information includes, in addition to the sound source category [CD], pieces of information such as a title of the music under the playing at the present, a name of the singer (a name of the player), a title of the album in the case of selecting the CD, and includes pieces of information such as a name of the radio station to which the seater listens at the present, a frequency of the radio station, a title of the radio program in the case of selecting the FM radio. This type of sound source selection status screen may be set as a top screen for the operation of changing the sound source, and may also be displayed at all times.

For example, in FIG. 8, the FM radio is selected as the sound source at the driver seat, and the frequency is tuned to 80.0 MHz. The CD is selected as the sound source at the passenger seat, and the seater listens to a certain title of music. At the seat behind the driver seat, the AM radio is selected as the sound source, and the frequency is tuned to 1242 KHz. At the seat in the rear of the passenger seat, the HDD is selected as the sound source, and the seater listens to a certain title of popular song.

The detailed information of the sound sources, which are played at the individual seats at the present, is displayed, thereby enabling, for example, the seater at the passenger seat in FIG. 8 to visually recognize what the seater at the seat behind the passenger seat listens to, and to change the sound source on the same screen to the sound source to which the seater at the seat behind the passenger seat listens when desiring, he or she thinks, to listen to the same sound source.

What is claimed is:

1. An acoustic control apparatus capable of playing individual sound sources in a plurality of individual spaces by executing an acoustic process for the plurality of individual spaces provided in a predetermined range of space, the acoustic control apparatus comprising:
an operation display unit enabling a sound source to be individually selected in each individual space; and
a playing control unit executing playing control of the sound source selected by the operation display unit in each individual space.

2. The acoustic control apparatus according to claim 1, further comprising
a remote control accepting unit accepting, from a remote control unit, a selection result of an individual space in which a sound source is played and the sound source used in the individual space as the selection result employed by the playing control unit, which are input to the remote control unit different from the operation display unit.

3. The acoustic control apparatus according to claim 1,
wherein the operation display control unit
displays an individual space selection screen for selecting at least one individual space in which the individual sound source is played from within the predetermined range of space,
displays a sound source selection screen for selecting, when the individual space is selected via the individual space selection screen, the sound source used with respect to the selected individual space from a plurality of sound sources usable within the predetermined range of space, and
accepts a selection result of the individual space and the sound source as the selection result employed by the playing control unit via the individual space selection screen and the sound source selection screen.

4. The acoustic control apparatus according to claim 1, wherein the operation display control unit
displays a sound source selection screen for selecting a desired sound source from a plurality of sound sources usable within the predetermined range of space,
displays, when the sound source is selected via the sound source selection screen, an individual space selection screen for selecting the individual space in which an acoustic data of the selected sound source is played from within the predetermined range of space, and
accepts the selection result of the individual space and the sound source as a selection result employed by the playing control unit via the sound source selection screen and the individual space selection screen.

5. The acoustic control apparatus according to claim 1,
wherein the operation display unit displays categories of the sound sources played in the individual spaces within the predetermined range of space on the same screen.

6. The acoustic control apparatus according to claim 1,
wherein the playing control unit, when single sound source is played in the predetermined range of space as the selection result of the individual space and the sound source, playing the selected single sound source synchronously in the individual spaces.

7. The acoustic control apparatus according to claim 1,
wherein the playing control unit executes as a playing control at least any one of leak sound control of generating and outputting control sounds for canceling sounds leaking from other individual spaces with respect to each individual space, and localization control of generating a virtual sound field including a virtual sound image based on output signal of the sound source in the individual space with respect to each individual space, and correcting a position of a sound image.
